(19) United States
(12) Patent Application Publication
(10) Pub. No.: US 2005/0030161 A1
(43) Pub. Date: Feb. 10, 2005

(54) Method for indicating the functioning of a process automation field device

(76) Inventor: Gerhard Dittrich, Schopfheim (DE)

Correspondence Address: BACON & THOMAS, PLLC, 625 SLATERS LANE, FOURTH FLOOR, ALEXANDRIA, VA, 22314, US

(21) Appl. No.: 10/866,106

(22) Filed: Jun. 14, 2004

(30) Foreign Application Priority Data
Jun. 11, 2003 (DE) 10326627.5

(51) Int. Cl. H04Q 5/22

(52) U.S. Cl. 340/10.6

(57) ABSTRACT

In a method for the function checking of a process-automation field device, a radio signal is transmitted from a transmitting unit to the field device, and, with the help of this radio signal, a query of the device status is triggered in the field device. Depending on the result of the query of the device status, a corresponding, perceivable signal is produced.

The invention relates to a method for indicating the functioning of a process automation field device, according to the preamble of claim 1.

In process automation, field devices are used in many cases for the registering and/or influencing of process variables.

Examples of such field devices are fill level meters, mass flow meters, pressure and temperature meters, etc., which, as sensors, register the corresponding process variables fill level, flow rate, pressure and temperature.

For influencing process variables, there are the so-called actuators, e.g. valves, which influence the flow rate of a liquid through a section of a pipeline, or pumps, which influence the fill level in a container.

Along with sensors and actuators, input and output units (remote I/O's) are also referred to as field devices.

A large number of such field devices are manufactured and sold by the firm of Endress+Hauser®.

Frequently, field devices are connected to a process control system over a fieldbus (Profibus, Foundation Fieldbus, etc.). The process control system serves for process control, process visualization, process monitoring, as well as for the configuring and parametering of the field devices.

As a rule, microprocessor-controlled field devices have diagnosis functions, which monitor the proper operating condition of a field device. Malfunctions of a field device are reported by the field device to the process control system and suitably displayed in such on a graphical user interface.

Sometimes, a check of the functioning of field devices is also necessary on site, i.e. at the corresponding process component. For this purpose, a service technician must locate all field devices installed at the process component (e.g. a tank) and check them individually. In some instances, this must be done by selecting special menu items on the display of the particular field device.

Since field devices are sometimes located such that they are not easy to get at, this procedure for checking the functioning of field devices is extremely complicated.

An object of the invention is, therefore, to provide a method for function display of a field device for process automation, lacking the above-mentioned disadvantages and, especially, enabling a simple and rapid function check of a field device, performable at favorable cost.

This object is achieved by the method stated in claim 1.

Advantageous further developments are given in the dependent claims.

An essential idea of the invention is to transmit a radio signal from a transmitting unit to the field device and, in this way, to trigger a device status query in the field device. Conforming to the result of the device status query, a corresponding, perceivable signal is produced.

On the basis of this signal, the service technician can simply and rapidly recognize whether a field device has a malfunction, or not.

According to a further development of the invention, the signal is only produced, when a faultless device status exists.

In a further development of the invention, the signal is an optical signal. A very simple optical signal can be e.g. a blinking of the display.

Besides optical signals, acoustical signals are also conceivable.

The transmitting unit can be a simple, pocket-sized, hand transmitter. Such transmitting units are used in many areas of application, e.g. as garage door openers or as radio remote controls for motor vehicles. As mass-produced articles, they are quite cost-favorable.

The invention will now be explained in greater detail on the basis of an example of an embodiment presented in the drawings, whose figures show as follows:

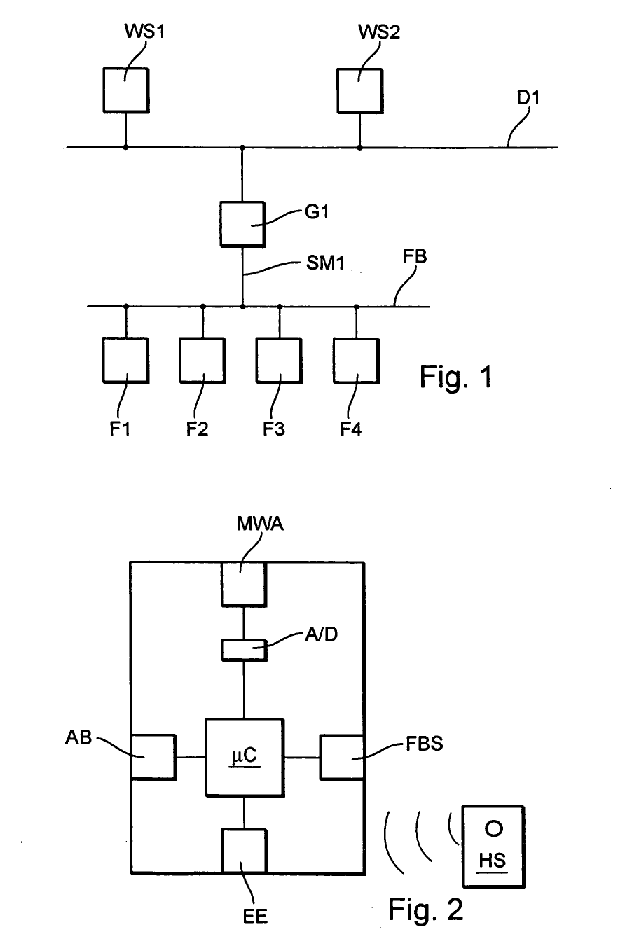

FIG. 1 A block diagram of a process automation communications network; and

FIG. 2 Block diagram of a field device for applying the method of the invention.

FIG. 1 details a process automation network. Connected to a databus D1 are a plurality of computer units, workstations WS1, WS2. These computer units serve as process control systems. They provide process visualization, process monitoring and the engineering, as well as the operating and monitoring of the field devices. The databus D1 works e.g. according to the Profibus FMS-standard or according to the HSE (High Speed Ethernet)—standard of Foundation Fieldbus. Over a gateway G1, which is also referred to as a linking device or a segment coupler, the databus D1 is connected with a fieldbus segment SM1. The fieldbus segment SM1 is composed of a plurality of field devices F1, F2, F3, F4, which are connected with one another over a fieldbus FB.

The field devices F1, F2, F3, F4 can be sensors and/or actuators.

The fieldbus FB works suitably according to one of the known fieldbus standards: Profibus®, Foundation Fieldbus® or HART®).

FIG. 2 details a field device in the form of a sensor. In the case of this sensor, a transducer MWA, which serves for registering a process variable, is connected via an analog/digital converter A/D (where the measured value is digitized) to a microcontroller μC.

The microcontroller μC is connected to a display/operating unit AB, which is an LCD-display with a plurality of keys. The LCD-display serves essentially for measured value display and for guiding the user through the operating menu of the field device. The microcontroller μC is additionally connected with a receiving unit EE.

The receiving unit EE serves to receive radio signals, which are produced by a hand-transmitter HS.

For connecting to the fieldbus, the microcontroller μC is connected with a fieldbus interface FBS.

The method of the invention will now be explained in greater detail. A service technician, desiring to query the device status of a field device, goes to the vicinity of the field device and actuates the hand-transmitter HS. A radio signal is transmitted from the hand-transmitter HS to the field device. After receiving the radio signal, a query of the device status occurs in the microcontroller μC. Depending on the result of the query, a corresponding signal (e.g. an optical signal) is produced. This optical signal, which can be e.g. the blinking of the LCD-display, signals to the service technician the faultless functioning of the called field device. Thus, with the help of the method of the invention, a simple check of difficultly accessible field devices is possible. Within a short time, a service technician can ascertain which field devices at a process component are working faultlessly.

Such a function test can also be easily performed by untrained assistants, e.g. during an inspection round.

1 A method for performing a function check of a process automation field device, comprising the steps of:
Transmitting a radio signal from a transmitting unit (HS) to the field device, which triggers a query of the field device status in the field device; and
producing a perceivable signal corresponding to the result of the device status query.

2 The method as claimed in claim 1, wherein:
said perceivable signal is only produced when a faultless device status is present.

3 The method as claimed in claim 1, wherein:
said perceivable signal is an optical signal.

4 The method as claimed in claim 1, wherein:
said perceivable signal comprises a blinking of a display provided at the field device.

5 The method as claimed in claim 1, wherein:
said perceivable signal is an acoustic signal.

6 The method as claimed in claim 1, wherein:
the transmitting unit HS is a pocket-sized hand-transmitter.

7 The method as claimed in claim 2, wherein:
said perceivable signal is an optical signal.

8 The method as claimed in claim 2, wherein:
said perceivable signal comprises a blinking of a display provided at the field device.

9 The method as claimed in claim 3, wherein:
said perceivable signal comprises a blinking of a display provided at the field device.

10 The method as claimed in claim 2 wherein:
the transmitting unit HS is a pocket-sized hand-transmitter.

11 The method as claimed in claim 3, wherein:
the transmitting unit HS is a pocket-sized hand-transmitter.

12 The method as claimed in claim 4, wherein:
the transmitting unit HS is a pocket-sized hand-transmitter.

13 The method as claimed in claim 5, wherein:
the transmitting unit HS is a pocket-sized hand-transmitter.
